(19) United States
(12) Patent Application Publication
(10) Pub. No.: US 2026/0058171 A1
(43) Pub. Date: Feb. 26, 2026

(54) ELECTRODE BOARD FOR A BIPOLAR PLATE AND BIPOLAR PLATE FOR A FUEL CELL STACK, METHOD FOR MANUFACTURING A FUEL CELL STACK

(71) Applicant: Robert Bosch GmbH, Stuttgart (DE)

(72) Inventor: Eberhard Maier, Koengen (DE)

(21) Appl. No.: 18/854,365

(22) PCT Filed: Apr. 3, 2023
(86) PCT No.: PCT/EP2023/058635

§ 371 Date: Oct. 4, 2024

(30) Foreign Application Priority Data
Apr. 21, 2022 (DE) 10 2022 203 895.9

(51) Int. Cl. H01M 8/0297; H01M 4/86

(52) U.S. Cl. CPC H01M 8/0297; H01M 2004/8694

(57) ABSTRACT

The invention relates to an electrode board, i.e. a cathode board or an anode board, for a bipolar plate (100) of a fuel cell stack, in particular for a fuel cell vehicle, said electrode board comprising a board alignment device (110/120) for aligning this electrode board (101/102) with respect to a second electrode board (102/101) corresponding thereto using the board alignment device (120/110) of the second electrode board during an assembly of the two electrode boards (102/101) to form the bipolar plate (100), wherein the board alignment device (110/120) at least partially forms a section (110/120) of a bipolar plate positioning device (105; 110, 120) of the bipolar plate (100) for stacking the bipolar plate (100) to form a fuel cell stack (10).

### BACKGROUND

The invention relates to an electrode board for a bipolar plate and a bipolar plate for a fuel cell stack. The invention further relates to a method for assembling a bipolar plate, as well as a method for stacking bipolar plates.

In a low-temperature polymer electrolyte fuel cell of a fuel cell aggregate (stationary or mobile), e.g. of a fuel cell system or a fuel cell vehicle, an electrochemical conversion of two reactants of two operating media into electrical energy and heat takes place. The fuel cell in this case comprises at least one membrane electrode assembly (MEA). As a rule, the fuel cell is designed to comprise a plurality of membrane electrode assemblies arranged in a stack and bipolar plates arranged between them (fuel cell stack).

### SUMMARY

Space on the two large sides of a bipolar plate for a fuel cell stack is limited, and thus ‘precious’.—Therefore, the object of the invention is to specify a bipolar plate whose electrical active surfaces can be cathode-side and/or anode-side, and/or whose port surfaces for the operating media and/or the cooling medium can be exploited well in order to be able to provide a high-performance bipolar plate, and thus a high-performance fuel cell stack.

The object of the invention is achieved by means of an electrode board, i.e. a cathode board and/or an anode board for a bipolar plate, and by means of a bipolar plate for a fuel cell stack of a fuel cell, in particular for a fuel cell vehicle. Furthermore, the object of the invention is achieved by a method for assembling a bipolar plate, as well as by a method for stacking bipolar plates to form a fuel cell stack for a fuel cell, in particular for a fuel cell vehicle.—Advantageous embodiments, additional features, and/or advantages of the invention are apparent from the following description.

The electrode board according to the invention comprises a board alignment device for aligning this electrode board with respect to a second electrode board corresponding thereto using the board alignment device of the second electrode board for assembling the two electrode boards to form the bipolar plate, whereby the board alignment device (chronologically following the assembly of the two electrode boards to the bipolar plate) at least partially forms a region of a bipolar plate positioning device of the bipolar plate for stacking the bipolar plates to form a fuel cell stack.

In other words, the board alignment device, e.g. two continuous passages, the one electrode board (cathode board or anode board of the resulting bipolar plate), and the board alignment device of the second electrode board, e.g. two corresponding continuous passages (anode board or cathode board of the resulting bipolar plate), together form the bipolar plate positioning device when in an assembled state in order to form the bipolar plate. The bipolar plate positioning device is then used to position the bipolar plate when stacking the bipolar plate together with other bipolar plates to form the fuel cell stack.

A contour of the board alignment device can be formed in the electrode board such that this contour can become substantially (merely partially, point-wise, or sectionally) congruent with a contour of the board alignment device of the second electrode board for the same bipolar plate.—In other words (see also FIGS. 3 to 5), when assembling the bipolar plate, its two electrode boards (cathode board and anode board) can merely be placed on top of each other such that the contours of the continuous passages corresponding to each other (alignment holes, alignment slots (see below)) of the two board alignment devices can merely become congruent in a partial, point-wise, or sectional manner. For example, corresponding continuous passages of the two electrode boards in this context are of course (at least sectionally) substantially arranged concentrically with respect to one another, one on top of the other.

The electrode board cannot comprise a bipolar plate positioning device for a bipolar plate that is functionally substantially or completely separate from its board alignment device and is at least partially separate. In other words, the board alignment device and the partial bipolar plate positioning device (i.e., the area that the respective electrode board provides for the bipolar plate positioning device of the subsequent bipolar plate) are at least partially or completely integrated into each other (in the latter case, they are the same). Of course, an additional alignment aid, e.g. an alignment bead, can be formed in the respective electrode board and substantially only be used to align two electrodes corresponding to each other when assembling the bipolar plate.

The board alignment device can be formed within, substantially entirely within, or exclusively within the electrode board. In other words, the board alignment device is not, in particular also not sectionally, constituted by a peripheral edge, in particular an outer peripheral edge of the electrode board. The board alignment device can comprise at least one passage, in particular at least one continuous passage in the electrode board. The board alignment device can comprise an alignment hole on the one hand and an alignment slot in the electrode board on the other. The alignment hole and the alignment slot can be arranged at a distance from one another in opposing longitudinal end portions in the electrode board. Preferably, the alignment hole and the alignment slot are arranged at a rectilinear or diagonal distance in the opposing longitudinal end portions of the electrode board.

The bipolar plate according to the invention comprises a cathode board and an anode board fixedly connected thereto, whereby a board alignment device of the cathode board and a board alignment device of the anode board, by means of which the cathode board and the anode board have been aligned with each other in the bipolar plate, at least partially together (through each other or between each other) form a bipolar plate positioning device for stacking the bipolar plate to form a fuel cell stack. In other words, the board alignment devices of both the cathode board and the anode board at least partially together form the bipolar plate positioning device of this bipolar plate for stacking this bipolar plate to form a fuel cell stack.

In this case, a combination of board alignment devices (in their entirety) for the cathode board and the anode board can at least partially form the bipolar plate positioning device of the bipolar plate. Furthermore, neither the cathode board nor the anode board can comprise a board alignment device for merely mutually aligning the cathode board and the anode board with respect to the bipolar plate. Furthermore, the bipolar plate cannot comprise a board alignment device separate from its bipolar plate positioning device, in particular neither section-wise on its cathode board nor section-wise on its anode board. The exception can in this case optionally be an additional alignment aid (see above).

The cathode board and the anode board are fixed, one on top of the other, to form a bipolar plate. In this case, the contours of the board alignment devices of the cathode board and the anode board corresponding to each other can be configured such that a contour of a first board alignment device becomes substantially (merely partially, point-wise, or sectionally) congruent with a contour of a second board alignment device. Furthermore, in an overhead view of the bipolar plate, a contour of a first board alignment device in or around a contour of a second board alignment device can be inscribed or circumscribed.

This applies in particular to an alignment hole (see below and also above) of the board alignment devices or an alignment double hole (alignment holes lying one above the other) of the bipolar plate positioning device. In this case, an n-cornered circular contour (protrusions) of the one electrode board can, e.g., be inscribed in a circular contour of the second electrode board (obviously only an overhead view; see FIGS. 3 to 5 on the left, alignment holes).—Preferably, the contours of the board alignment device of the cathode board (electrode board) are ‘inscribed’ at least section-wise into the contours of the board alignment device of the anode board (the other electrode board), or the contours of the board alignment device of the anode board (the electrode board) are ‘circumscribed’ at least section-wise around the contours of the board alignment device of the cathode board (the other electrode board).

In an overhead view of the bipolar plate, a surface of a first board alignment device can be formed in the bipolar plate such that this surface becomes congruent merely section-wise with a surface of a second board alignment device. In particular, this applies in each case to an alignment slot (see below and also above) of the board alignment devices or an alignment double slot (superimposed alignment slots) of the bipolar plate positioning device. In this case, a (section-wise or sector-wise) partial surface of the board alignment device of the cathode board (the electrode board) can become congruent with a (section-wise or sector-wise) partial surface of the board alignment device of the anode board (the other electrode board; obviously only in the top view). See FIGS. 3 to 5, each on the right (alignment slots).

The board alignment devices of the cathode board and the anode board can form two plate stack continuous passages in the bipolar plate for stacking the bipolar plate in the fuel cell stack. In other words, the two plate stack continuous passages at least partially constitute the bipolar plate positioning device. Both the board alignment device of the cathode board and the board alignment device of the anode board can each comprise two continuous passages, whereby these four continuous passages form two continuous passages in the bipolar plate as a bipolar plate positioning device. The two continuous passages can each be designed as an alignment hole and an alignment slot in both the cathode board and the anode board, which form an alignment double hole and an alignment double slot in the bipolar plate as a bipolar plate positioning device.

The alignment hole of the one board alignment device can comprise only one circular contour, and the alignment hole of the other board alignment device can comprise a circular contour with protrusions. The protrusions of the circular contour are in this case preferably arranged in the corner areas of a regular polygon. The alignment hole with the exclusively circular contour is preferably formed in the anode board and the alignment hole with the indented circular contour is preferably formed in the cathode board. However, this can of course be designed in reverse.

The alignment slot of the one board alignment device can be designed as an elongate hole, and the alignment slot of the other board alignment device can be designed as a tapered or stepped elongate hole. The alignment slot in the form of an elongate hole is preferably formed in the anode board, and the alignment slot in the form of a tapered or stepped elongate hole is preferably formed in the cathode board. However, this can of course be designed in reverse. The alignment hole comprising the circular contour with protrusions can be inscribed in the alignment hole with the exclusive circular contour, and the alignment slot in the form of a tapered or stepped elongate hole can be at least partially inscribed in the alignment slot (obviously again in the top plan view).

In the method according to the invention for assembling a bipolar plate for a fuel cell stack, a cathode board and an anode board of the resulting bipolar plate are aligned with each other during an alignment step of the method, then fixed to each other in a chronologically subsequent fastening step of the method, whereby, during the alignment step, the cathode board and the anode board are mutually aligned by board alignment devices of the cathode board and the anode board, and the plate alignment devices at least partially form a bipolar plate positioning device in the resulting bipolar plate for stacking the bipolar plate to form a fuel cell stack. In the method for assembling the bipolar plates, a preferably single cathode board and a preferably single anode board are each joined to form a respective bipolar plate.

Preferably, the board alignment devices of the cathode board and the anode board each comprise two continuous passages.—In the alignment step, continuous passages of the cathode board and the anode board corresponding to each other can, at least section-wise, be arranged substantially concentrically with respect to each other. Also during the alignment step, a profiled alignment means of a board alignment means can be used to center two continuous passages of the cathode board and the anode board in an intermediate plane (or a plane parallel thereto) with respect to each other. The profiled alignment means for insertion through the continuous passages is preferably designed as an assembly pin. The centering region of the alignment means can comprise a preferably straight section having a polygonal, in particular a preferably triangular, quadrilateral, or pentagonal cross-section.

Also during the alignment step, two continuous passages corresponding to each for the profiled alignment means can be designed as an alignment hole with an exclusive circular contour and an alignment hole with a circular contour with protrusions. In this case, the alignment hole with the circular contour with protrusions is, when seen from above, inscribed in the alignment hole with the exclusive circular contour. When centering, the profiled alignment means sits with its outer corners or outer edges on the one hand in the protrusions of the circular contour with protrusions on the inside of the cathode board/anode board, and on the other hand the profiled alignment means sits with these outer corners or outer edges on the inside of the circular contour of the anode board/cathode board (see FIG. 4, left).

Moreover, an alignment means of a/the board alignment means can be used to align, i.e. inhibit, two continuous passages of the cathode board and the anode board corresponding to each another in one or exactly one translational or rotational degree of freedom in one/the intermediate plane (the other degrees of freedom can be achieved conditionally). The preferably cylindrical or conical section-shaped alignment means for insertion through the continuous passages is preferably designed as an assembly pin.

Furthermore, two continuous passages corresponding to each other for the alignment means can be designed as an alignment slot in the form of an elongate hole, and as an alignment slot in the form of a tapered or stepped elongate hole. In this case, the alignment slot is at least partially inscribed as a tapered or stepped elongate hole in the alignment slot in the form of an elongate hole (in the top plan view). During alignment (one above the other), the preferably cylindrical or conical section-shaped alignment means sits with its outer circumference on the inside of the elongate hole on the cathode board/anode board on the one hand and, on the other hand, the preferably cylindrical or conical section-shaped alignment means sits with its outer circumference on the inside of the tapered or stepped elongate hole (preferably larger diameter) of the anode board/cathode board (see FIG. 4, right). In this case, the elongate hole and the tapered or stepped elongate hole have substantially the same diameter in the area in question.

The cathode board and the anode board can be fixed to each other, in particular welded to one another, during a fastening step of the assembly method after the alignment step. The cathode board and/or the anode board can be designed as an electrode board according to the present invention. Furthermore, the bipolar plate can according to the invention be formed after the fastening step of the assembly method.

In the method according to the invention for stacking bipolar plates to form a fuel cell stack, a plurality of bipolar plates with membrane electrode assemblies located therebetween are stacked on top of one another to form a fuel cell stack using a bipolar plate stacking means, whereby the stacking of a bipolar plate in the fuel cell stack is performed by a bipolar plate positioning device in the bipolar plate, and this bipolar plate positioning device is at least partially constituted by board alignment devices of the electrode boards of the bipolar plate, by which the electrode boards have been mutually aligned for their assembly to the bipolar plate.

The bipolar plate positioning device can comprise two plate stack continuous passages. In this case, a single plate stack continuous passage can be formed by a double continuous passage of the board alignment devices of the electrode boards. Furthermore, a single continuous passage of the two continuous passages of the electrode boards corresponding to each other can be centered or positioned by a stacking means of the bipolar plate stack means, whereby the bipolar plate is positioned to form the fuel cell stack. For this purpose, the stacking means preferably comprises a cylindrical portion for insertion through the respective plate stack continuous passage.

Moreover, a respective plate stack continuous passage can be formed from an alignment double hole and an alignment double slot of the plate alignment devices of the electrode boards of the bipolar plate. Furthermore, a single alignment hole of the alignment double hole can effectively be centered by a stacking means of the bipolar plate stacking means, whereby this alignment hole preferably comprises a circular contour with protrusions (see FIG. 5, left). Furthermore, a single alignment slot can be effectively centered or positioned by a stacking means of the bipolar plate stacking means, whereby said alignment slot is preferably formed as a tapered or stepped elongate hole (see FIG. 5, right). In this case, a tapered or narrower section of the elongate hole is preferably centered or positioned by the stacking means.

When stacking bipolar plates, bipolar plates can be stacked with membrane electrode assemblies provided thereon, or bipolar plates and membrane electrode assemblies can be stacked alternately. Positioning of the bipolar plate during stacking of the bipolar plate to form the fuel cell stack can be performed by merely a single electrode board of the bipolar plate. The electrode board that is thicker than the other electrode board of the same bipolar plate is preferable in this case. This is usually the cathode board. The bipolar plate can be designed as a bipolar plate according to the present invention. Furthermore, the bipolar plate can be assembled by means of a method according to the invention.

It should be noted in particular that a feature specified in the context of the method, in particular an apparatus feature specified therein (electrode board (cathode board, anode board), bipolar plate) is applicable to a claimed apparatus. Furthermore, a feature specified in the context of the apparatuses, in particular a method feature specified therein (assembly method, batch method), is applicable to a claimed method. This also applies to the following description of the invention.

### BRIEF DESCRIPTION OF THE DRAWINGS

The invention is explained in further detail hereinafter by way of the attached schematic drawings, which are not to scale, with reference to exemplary embodiments. Regarding the invention, a feature can be designed to be positive, i.e. present, or negative, i.e. absent. In the present specification, a negative feature is not explicitly explained as a feature unless it is described as being absent according to the invention. In other words, what is actually achieved—and not an invention construed via the prior art—consists of omitting this feature. The absence of a feature (negative feature) in an exemplary embodiment demonstrates that the feature is optional.—Shown in the figures (Figs.) of the drawings are, purely by way of example:

FIG. 1 a simplified block diagram of an embodiment of a fuel cell aggregate for a fuel cell system of a fuel cell vehicle,

FIG. 2 an overhead view of a bipolar plate formed from a cathode board and an anode board for a fuel cell stack according to the prior art,

FIG. 3, omitting other outlines of a bipolar plate, shows a bipolar plate positioning device according to the invention, formed from plate alignment devices of the cathode board and the anode board of the bipolar plate,

FIG. 4 a function of the board alignment devices of a cathode board (reference signs are solid underlined, also FIGS. 3 and 5) and an anode circuit board (reference signs are dashed underlined, also FIGS. 3 and 5) when assembling to a bipolar plate,

FIG. 5 a function of the bipolar plate positioning device at least partially constituted by the plate alignment devices of the cathode board and the anode board when stacking the bipolar plate in a fuel cell stack, and

FIGS. 6 and 7 simplified flow diagrams of a method for assembling a bipolar plate (FIG. 6) and a method for stacking bipolar plates to form a fuel cell stack (FIG. 7).

### DETAILED DESCRIPTION

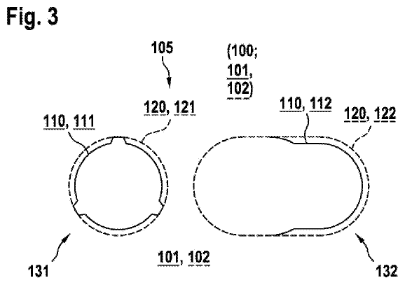

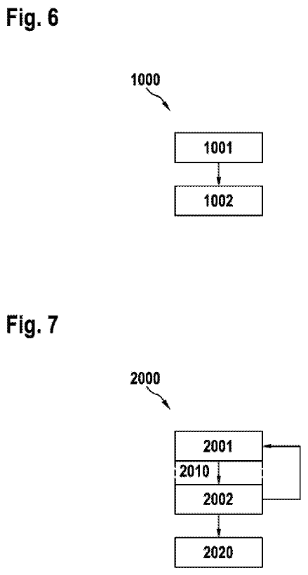

The invention is explained in greater detail with reference to an electrode board 101/102, i.e. a ‘half’ bipolar plate 100, i.e. a cathode board 101 or an anode board 102, and a bipolar plate 100 (see FIGS. 3 to 5), and by means of a method 1000 for assembling a bipolar plate 100 (see FIG. 6) and a method for stacking 2000 bipolar plates 100 to form a fuel cell stack 10 (see FIG. 7) for a low-temperature polymer electrolyte fuel cell system of a fuel cell vehicle, i.e., a motor vehicle comprising a fuel cell or fuel cell system.

Only those portions of the fuel cell system that are necessary for an understanding of the invention are shown in the drawings. Although the invention is described and illustrated in more detail by way of preferred embodiments, the invention is not limited by the exemplary embodiments disclosed. Other variations can be derived thereby without departing from the protective scope of the invention.

FIG. 1 shows the fuel cell aggregate 1 according to one preferred embodiment, comprising at least one, in particular a plurality, of single electrochemical fuel cells 11, 11, . . . bundled together to form a fuel cell stack 10, said single cells 11, 11, . . . being housed in a preferably fluid-tight stack housing 16. Each single cell 11 comprises an electrode chamber 12, preferably with a gas diffusion layer (optionally including a microporous particle layer), which is designed as an anode chamber 12, and an electrode chamber 13, which is designed as a cathode chamber 13, preferably with a gas diffusion layer (optionally including a microporous particle layer), which are spatially and electrically separated from each other by a membrane-electrode assembly 15. In this case, the gas diffusion layers are preferably associated with the membrane-electrode assembly 15.

Arranged in each case between two directly adjacent membrane-electrode assemblies 15, 15—including a respective anode chamber 12 and a cathode chamber 13—is a bipolar plate 100 (separator board assembly 100, preferably consisting of an anode board 102 (electrode board 102, monopolar board 102) and a cathode board 101 (electrode board 101, monopolar plate 101)). Among other things, said bipolar plate is used to feed/discharge operating media 3, 5 into an anode chamber 12 of a first single cell 11 and a cathode chamber 13 of a second single cell 11 directly adjacent to thereto and, in addition, to achieve an electrically conductive connection between these single cells 11, 11.

The fuel cell aggregate 1 comprises an anode supply 20 and a cathode supply 30 for supplying the fuel cell stack 10 with its actual operating media 3 (anode operating medium, actual fuel), 5 (cathode operating medium, usually air).—The anode supply 20 comprises in particular: a fuel reservoir 23 for the anode operating media 3 (flowing in); an anode supply path 21 having a shut-off/metering valve 27 and an ejector 24; an anode exhaust path 22 for an anode exhaust medium 4 (flowing out, usually into the environment 2); preferably a fuel recirculation line 25 with a fluid conveying device 26 located therein and optionally a water separator.

The cathode supply 30 in particular comprises: a cathode supply path 31 for the cathode operating medium 5 (flowing in, usually from the surrounding environment 2), preferably with a fluid conveying device 33; a cathode gas path 32 for a cathode exhaust gas medium 6 (flowing out, usually into the environment 2) preferably with a turbine 34, optionally of an exhaust turbocharger, in particular for the fluid conveying device 33; preferably a moisture transfer device 36; optionally a waste gate 35 between the cathode supply path 31 and the cathode exhaust gas path 22; and optionally a water separator.

The fuel cell aggregate 1 also comprises, in particular, a cooling medium, supply 40, through which the fuel cell can be integrated into a cooling circuit for temperature adjustment, preferably by means of its bipolar plates 100 (cooling medium paths 43). The cooling medium supply 40 comprises a cooling medium inlet path 41 and a cooling medium outlet path 42. The cooling medium 7 (flowing in), 8 (flowing out) circulating in the cooling medium supply 40 is preferably conveyed by means of at least one cooling medium conveying device 44.—In addition to the fuel cell aggregate 1, the fuel cell system comprises peripheral system components, e.g. a control device, which can be one of the fuel cell vehicle itself.

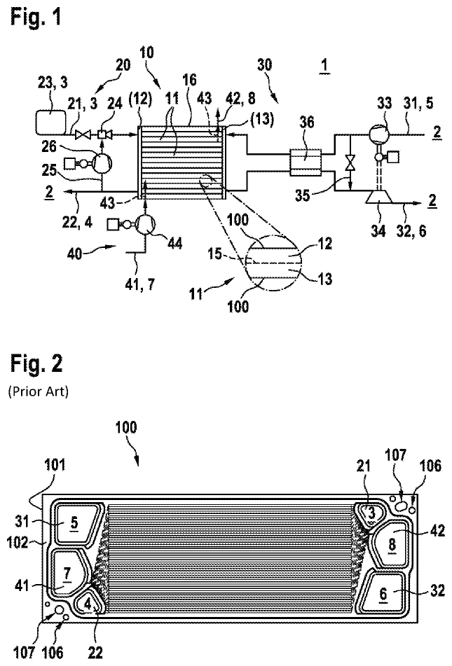

Prior art.—FIG. 2 shows a bipolar plate 100 according to the prior art, whereby the bipolar plate 100 comprises two electrode boards 101, 102 welded to each other, a cathode board 101, and an anode board 102. In addition to its flow fields for the media and its ports of paths 21, 22, 31, 32, 41, 42, the bipolar plate 100 comprises a bipolar plate positioning device 107 (prior art only) and a separate board alignment device 106 (prior art only).

In this case, the relevant (double) continuous passages of the bipolar plates positioning device 107 and the board alignment device 106 are arranged ii a respective longitudinal end section of the bipolar plate 100 (i.e., top right and bottom left in FIG. 2) by means of a bar, i.e. the ‘flesh’ of the bipolar plate 100, adjacent to one another in the bipolar plate 100. In other words, a comparatively large amount of space is required on the bipolar plate 100 to align the electrode boards 101, 102 with the bipolar plate 100 and stack the bipolar plate 100 in the fuel cell stack 10, which is not available for subsequent operation of the bipolar plate 100 (dead space).

In a method for assembling such a bipolar plate according to the prior art, a cathode board 101 and an anode board 102 are mutually aligned using a board alignment device (106) in the cathode board 101 and a board alignment device (106) in the anode board 102. If the cathode board 101 and the anode board 102 are aligned using the board alignment device 106, then they are welded together.

In a subsequent method for stacking such assembled bipolar plates 100 to form a fuel cell stack 100, the layers 100, 15 of the fuel cell stack 10—i.e., the alternating bipolar plates 100 and membrane electrode assemblies 15—are positioned in the bipolar plates 100 and membrane electrode assemblies 15 using a bipolar plate positioning device 107.—A total of eight continuous passages in the two electrode boards 101, 102 and four (double) continuous passages in a single bipolar plate 100 are required for the assembly process and the stacking process.

In the context of the invention (see below) the reference signs in FIGS. 3 to 5 are underlined solid if they belong to the cathode board 101 of the bipolar plate 100, and the reference signs are underlined dashed if they belong to the anode board 102 of the same bipolar plate 100. It is of course possible to reverse this.

When stacking a fuel cell sack 10 using a bipolar plate positioning device, the hole and slot concept is, e.g., used (similar to FIG. 3). The bipolar plates 100 and the membrane electrode assemblies 15 can thus be stacked very precisely on top of each other to form a fuel cell stack 10. Ideal tolerances can be achieved if only one side of a bipolar plate 100 consisting of a cathode board 101 and an anode board 102 is used to precisely position the bipolar plate 100. This is preferably the side of the bipolar plate 100 that has a greater layer thickness. In the present case, this is preferably a cathode board 101, which in the current case is designed to be approximately 0.2 mm thicker than an anode board 102.

Therefore, the cathode board 101 has a diameter of, e.g., 8.0 mm at its stack hole 111, and the anode board 102 has a diameter of, e.g., 8.4 mm at its stack hole 121. In other words, the diameter of the stack hole 111 of the cathode board 101 is smaller than (and not less than or equal to) the diameter of the stack hole 121 of the anode board 102. If the stack holes 111, 121 of both the cathode board 101 and the anode board 102 had the same diameter, a common (double) continuous passage 111, 121 (see below, a plate positioning stack hole 131 (111, 121)) in the bipolar plate 100 would be approximately 7.8 mm due to positioning and tolerances, or would have approximately the shape of an oval in an overhead view. A chosen stack pin 301 of a bipolar plate stacking means 300 would need to be correspondingly smaller in order to stack the fuel cell stack 10 (see below).

If the stack holes 111, 121 are arranged concentrically and the stack hole 111 of the cathode board 101 has a diameter of 8.0 mm and the stack hole 121 of the anode board 102 has a diameter of 8.4 mm, then the stack pin 301 can only be aligned with the cathode board 101 and can have a diameter of almost approximately 8.0 mm (similar to FIG. 5, left). The diameters and optionally the lengths of the stack slots 112, 122 (see below, a plate positioning stack slot 132 (112, 122)) in the cathode board 101 and the anode board 102 can be proceeded with in a similar way (see FIG. 5, right). A fuel cell stack 10 can thus be constructed manually or automatically in a safe manner, with low tolerances, and efficiently.-Diameters other than the sizes specified can of course be used.

However, the cathode board 101 and the anode board 102 must be aligned with one another chronologically earlier, i.e., when assembling the cathode board 101 and the anode board 102 to form the bipolar plate 100. If the stack holes 111, 121 are each merely designed as circular and differently sized stack holes 111, 121, and the stack slots 112, 122 are, e.g., each merely designed as straight and differently sized slotted holes 112, 122, then these cannot be used for aligning the cathode board 101 with the anode board 102, because the cathode board 101 cannot otherwise be correctly aligned with the anode board 102.

According to the invention (see FIGS. 3 to 6), a board alignment device 110 of the electrode board 101, e.g. the cathode board 101, and a board alignment device 120 of the electrode board 102, e.g. the anode board 102, constitute a bipolar plate positioning device 105 in the bipolar plate 100 (board-bound: 110, 120, or cross-board: 131, 132 (see below)). In other words, the board-bound board alignment device 110 is designed as a portion 110 of the bipolar plate positioning device 105, and the board-bound board alignment device 120 is also designed as a portion 120 of the bipolar plate positioning device 105.

In this case, the board alignment devices 110, 120 (see FIG. 5) serve to mutually align the electrode boards 101, 102 in a method 1000 for assembling a bipolar plate 100 during an alignment step 1001 of the assembly method 1000. In a subsequent step 1002 of the method 1000 (a fastening step 1002) the electrode boards 101, 102 are fixed together. Subsequently, such a bipolar plate 100 can be stacked in a fuel cell stack 10 (method 2000; see hereinafter).

The bipolar plate positioning device 105 formed from the board alignment devices 110, 120 (plate stack continuous passages 131, 132, see below) is used to subsequently stack the bipolar plate 100 to form the fuel cell stack 10. Such a method for stacking 2000 bipolar plates 100 to form a fuel cell stack 10 is illustrated in FIG. 7. In this case, either the bipolar plates 100 (steps 2001) and the membrane electrode assemblies 15 (steps 2002) are stacked alternately, or the bipolar plates 100 comprising the membrane electrode assemblies 15 provided thereon are stacked (alternative steps 2010 to steps 2001, 2002). When the fuel cell stack 10 comprises its intended number of layers, the stacking method 2000 ends in step 2020. Subsequently, the fuel cell stack 10 can, e.g., be accommodated in the stack housing 16.

The board alignment device 110 comprises two continuous passages 111, 112 in the electrode board 101, and the board alignment device 120.

comprises two continuous passages 121, 122 in the electrode board 102. Continuous passages 111, 121/112, 122 corresponding to each other are arranged substantially concentrically in the bipolar plate 100.—In the present case, continuous passages 111, 121 corresponding to each other can be designed as alignment holes 111, 121, and continuous passages 112, 122 corresponding to each other can be formed as alignment slots 112, 122 in the electrode boards 101, 102. Other forms of continuous passages 111, 121/112, 122 corresponding to each other can obviously be used.

Continuous passages 111, 121/112, 122 in the board alignment devices 110, 120 corresponding to each other each form a plate stack continuous passage 131, 132 of the bipolar plate positioning device 105. In the present case, the plate stack continuous passage 131 is designed as a plate positioning stack hole 131 spanning the plate, which can also be designated as a substantially concentric alignment double hole 111, 121. Furthermore, in the present case, the plate stack continuous passage 132 is designed as a plate positioning stack slot 132 spanning the boards, which can also be designated as a substantially concentric alignment double slot 112, 122.

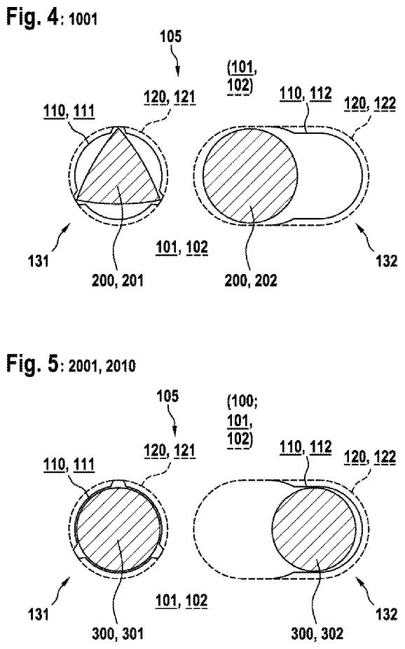

For the assembly method 1000 of the bipolar plate 100, a board alignment means 200 is used to engage with the board alignment devices 110, 120 of the electrode boards 101, 102 (FIG. 4). In this case, the board alignment means 200 comprises a preferably profiled alignment means 201, in particular an assembly pin 201, for insertion through the continuous passages 111, 121. Furthermore, the board alignment means 200 comprises a preferably cylindrical or conical section-shaped alignment means 202, in particular an assembly pin 201, for insertion through the continuous passages 112, 122.

In the stacking method 2000 for the fuel cell stack 10, a bipolar plate stacking means 300 is used to engage the bipolar plate positioning device 105 (110, 120) of the bipolar plate 100 (FIG. 5). In this case, the bipolar plate stacking means 300 comprises a preferably cylindrical stacking means 301, in particular a stacking pin 301, for insertion through the continuous passages 111, 121. Furthermore, the bipolar plate stacking means 300 comprises a preferably cylindrical stacking means 302, in particular a stacking pin 302, for insertion through the continuous passages 112, 122.

In the present case, the alignment hole 121 (continuous passage 121) substantially has only a circular contour 121, whereas the alignment hole 111 (continuous passage 111) has a circular contour with protrusions 111. In this case (during the alignment of the electrode boards 101, 102 and for stacking the bipolar plate 100), the circular contour with protrusions 111 is inscribed in particular with its protrusions in the circular contour 121 (FIGS. 3 to 5, left).

Furthermore, in the present case the alignment hole 122 (continuous passage 122) substantially has only a straight, elongate hole contour 122, whereas the alignment hole 112 (continuous passage 112) has a tapered or stepped elongate hole contour 112. In this case (also when aligning the electrode boards 101, 102 and for stacking the bipolar plate 100), the tapered or stepped elongate hole contour 112 is inscribed in particular with its wider portion in the straight elongate hole contour 122 (FIGS. 3 to 5, right).

During the alignment step 1001, the profiled assembly pin 201 engages in protrusions of the circular contour with protrusions 111 and, in contrast, centers the exclusive circular contour 121, or vice versa, whereby the electrode boards 101, 102 are aligned at a longitudinal end (FIG. 4, left).—Also during the alignment step 1001, the cylindrical or conical section-shaped assembly pin 202 engages the straight elongate hole contour 122 and aligns the tapered or stepped elongate hole contour 112 with it, or vice versa, thereby aligning the electrode boards 101, 102 at a different longitudinal end (FIG. 4, right). In this case, the cylindrical or conical section-shaped assembly pin 202 engages the straight elongate hole contour 122 and a wider portion of the tapered or stepped elongate hole contour 112.

When stacking 2001, 2010, merely the circular contour having protrusions 111 is centered on the cylindrical stacking means 301, or vice versa, whereby the bipolar plate 100 is positioned at a longitudinal end. The larger exclusively circular contour 121 does not center directly on the cylindrical stacking means 301, but indirectly over the composite of the electrode boards 101, 102.—Furthermore, during stacking 2001, 2010, the cylindrical stacking means 301 engages the tapered or stepped elongate hole contour 112, or vice versa, whereby the bipolar plate 100 is positioned at a different longitudinal end (FIG. 5, right). The straight elongate hole contour 122, sections of which are larger, does not center directly on the cylindrical stacking means 302, but indirectly via the composite of the electrode boards 101, 102.

Summary.—Continuous passages 111, 121/112, 122 (in each case across the board alignment devices 110, 120) of the electrode boards 101, 102 (electrode boards 101, 102 not fixed to one another) corresponding to each other can in particular be designed such that they can be centered/aligned with respect to each other in one or exactly one degree of freedom by an alignment means 201 (alignment holes 111, 121, optionally alignment slots 112, 122, alternatively or additionally), and/or can be aligned flush to each other in one or exactly one degree of freedom to each other by an alignment means 202 (alignment slots 112, 122, optionally alignment holes 111, 121, alternatively or additionally; see FIG. 4).

Furthermore, a single plate stack continuous passage 131 (111, 121)/132 (112, 122) of the bipolar plate 100 (electrode boards 101, 102 fixed to each other) can be designed in particular such that the bipolar plate 100 can be positioned only through a single continuous passage 111/112 of the continuous passages 111, 121/112, 122 of the plate stack continuous passage 131 (111, 121)/132 (112, 122) corresponding to each other by means of a stacking means 301/302 during stacking (see FIG. 5). Preferably, both plate stack continuous passages 131 (111, 121)/132 (112, 122) are designed in this way. Such a merely single respective continuous passage 111, 112 is in particular associated with a board alignment device 110 of a single electrode board 101 of the bipolar plate 100. A thicker one of the two electrode boards 101, (102) is preferred in this case; this is usually the cathode board 101.

If the continuous passages 111, 121 (alignment holes 111, 121, subsequent plate stack continuous passage 131) corresponding to each other each have a circular shape globally (see FIGS. 3 to 5, left), then these are centered together in the assembly method 1000 by the preferably profiled alignment means 201 of the board alignment means 200 (step 1001; see FIG. 4, left). The profiled alignment means 202 sits with its corners or corner areas substantially on the interior in both continuous passages 111, 121 (centering).

Furthermore, in the stacking method 2000, the preferably cylindrical stacking means 301 of the bipolar plate stacking means 300, or vice versa (step 2001 or step 2010; see FIG. 5, left) centers in this resulting plate positioning continuous passage 131. However, only a single continuous passage 111 of the continuous passages 111, 121 corresponding to each other centers as the plate positioning continuous passage 131, and this is the continuous passage 111 which is inscribed in the continuous passage 121 in the top plan view.

If the continuous passages 112, 122 (alignment slots 112, 122, subsequent plate stack continuous passage 132) corresponding to each other each have a elongate hole shape globally (see FIGS. 3 to 5, right), then these are centered or aligned together by the preferably cylindrical or conical section-shaped alignment means 202 of the board alignment means 200 during the assembly method 1000 according to the invention (step 1001; see FIG. 4, right). In this case, the alignment means 202 are formed in a first longitudinal end portion (in FIG. 4, this is the left longitudinal end portion) of the continuous passages 112, 122 in the form of elongate holes. The alignment means 202 substantially sits on the interior of both continuous passages 112, 122 (centering/alignment).

Furthermore, in the stacking method 2000, the preferably cylindrical stacking means 302 of the bipolar plate stacking means 300 is centered or aligned in this resulting plate positioning continuous passage 132, or vice versa (step 2001 or step 2010; see FIG. 5, right). However, in this case only a single continuous passage 112 of the continuous passages 111, 122 corresponding to each other centers or aligns as a plate positioning continuous passage 132, and this is the continuous passage 112 which is inscribed in the continuous passage 122 (when viewed from above). In this case, the stacking means 302 is formed in a second longitudinal end portion (in FIG. 4, this is the right longitudinal end portion) of the continuous passages 112, 122 in the form of elongate holes.

1. An electrode board (101/102), for a bipolar plate (100) of a fuel cell stack (10), said electrode board comprising:
a board alignment device (110/120) for aligning the electrode board (101/102) with respect to a second electrode board (102/101) corresponding thereto using the board alignment device (120/110) of the second electrode board during an assembly of the two electrode boards (102, 101) to form a bipolar plate (100), wherein
the board alignment device (110/120) at least partially forms a section (110/120) of a bipolar plate positioning device (105; 110, 120) of the bipolar plate (100) for stacking the bipolar plate (100) to form a fuel cell stack (10).

2. The electrode board (101/102) according to claim 1, wherein contour of the board alignment device (110/120) is formed in the electrode board (101/102) such that the contour can become substantially congruent, in a partial or section-wise manner, with a contour of the board alignment device (120/110) of the second electrode board (102/101) for the respective bipolar plate.

3. The electrode board (101/102) according to claim 1, wherein
the electrode board (101/102) does not comprise an at least partial bipolar plate positioning device for a bipolar plate (100) which is functionally, substantially, or completely separate from its board alignment device (110/120),
the board alignment device (110/120) is arranged within, substantially entirely within or exclusively within, the electrode board (101/102),
the board alignment device (110/120) comprises at least one passage (111/121, 112/122), in the electrode board (101/102), and/or
the board alignment device (110/120) comprises an alignment hole (111/121) and an alignment slot (112/122) in the electrode board (101/102).

4. A bipolar plate (100) for a fuel cell stack (10) of a fuel cell, in said bipolar plate comprising a cathode board (101) and an anode board (102) fixedly connected thereto, wherein
a board alignment device (110) of the cathode board (101) and a board alignment device (120) of the anode board (102), by which the cathode board (101) and the anode board (102) have been mutually aligned to form the bipolar plate (100), together at least partially form a bipolar plate positioning device (105) for stacking the bipolar plate (100) to form a fuel stack (10).

5. The bipolar plate (100) according to claim 4, wherein
a combination of the board alignment device (110, 120) of the cathode board (101) and the anode board (102) at least partially form the bipolar plate positioning device (105) of the bipolar plate (100),
neither the cathode board (101) nor the anode board (102) comprises a board alignment device (106) for mutually aligning the cathode board (101) and the anode board (102) to form the bipolar plate (100), and/or
neither the cathode board (101) nor anode board (102) of the bipolar plate (100) comprises a board alignment device (106) separate from the bipolar plate positioning device (107) thereof.

6. The bipolar plate (100) according to claim 4, wherein the cathode board (101) and the anode board (102) are fixed, one above the other, to form a bipolar plate (100) such that:
contours of the board alignment devices (110, 120) corresponding to each other are configured such that a contour of a first board alignment device (110/120) becomes substantially congruent, in a partial or section-wise manner, with a contour of a second board alignment device (120/120).
in an overhead view of the bipolar plate (100), a contour of a first board alignment device (110/120) is inscribed or circumscribed in or around a contour of a second board alignment device (120/110), and/or
in an overhead view of the bipolar plate (100), a surface of a first board alignment device (110/120) is formed in the bipolar plate (100) such that the surface becomes congruent merely section-wise with a surface of a second board alignment device (120/110).

7. The bipolar plate (100) according to claim 4, wherein
the board alignment devices (110, 120) of the cathode board (101) and the anode board (102) form two board stack continuous passages (131, 132) in the bipolar plate (100) for stacking the bipolar plate (100) into the fuel cell stack (10),
both the board alignment device (110) of the cathode board (101) and the board alignment device (120) of the anode board (102) each comprise two continuous passages (111, 112; 121, 122), wherein these four continuous passages (111, 112; 121, 122) form two continuous passages (111/121, 112/122) in the bipolar plate (100) as the bipolar plate positioning device (105), and/or
the two continuous passages (111, 112; 121, 122) in both the cathode board (101) and the anode board (102) are each formed as an alignment hole (111, 121) and an alignment slot (112, 122), which (111, 121; 112, 122) form an alignment double hole (111, 121) and an alignment double slot 112, 122 in the bipolar plate (100) as a bipolar plate positioning device (105).

8. The bipolar plate (100) according to claim 7, wherein
the alignment hole (121) of the one board alignment device (120) only has a circular contour (121), and the alignment hole (111) of the other board alignment device (110) has a circular contour with protrusions (111),
the alignment slot (122) of the one board alignment device (120) is designed as an elongate hole (122), and the alignment slot (112) of the other board alignment device (110) is designed as a tapered or stepped elongate hole (112), and/or
the alignment hole (111) having the circular contour with protrusions (111) is inscribed in the alignment hole (121) only having the circular contour (121), and the alignment slot (112) in the form of a tapered or stepped elongate hole (112) is at least partially inscribed in the alignment slot (122) in the form of an elongate hole (122).

9. A method (1000) for assembling a bipolar plate (100) for a fuel cell stack (10) of a fuel cell, wherein
during an alignment step (1001) of the method (1000), a cathode board (101) and an anode board (102) of the resulting bipolar plate (100) are aligned with each other and are fixed in a subsequent fastening step (1002) of the method (1000), wherein,
during the alignment step (1001), the cathode board (101) and the anode board (102) are mutually aligned by board alignment devices (110, 120) of the cathode board (101) and the anode board (102), and the board alignment devices (110, 120) at least partially form a bipolar plate positioning device (100) in the resulting (1002) bipolar plate (100) for stacking the bipolar plate (105) to form a fuel cell stack (10).

10. The assembly method (1000) according to claim 9, wherein the board alignment devices (110, 120) of the cathode board (101) and the anode board (102) each comprise two continuous passages (111, 112; 121, 122), wherein in the alignment step (1001): continuous passages (111, 121; 112, 122) of the cathode board (101) and the anode board (102) corresponding to each other are, at least section-wise, arranged substantially concentrically to one another, and wherein
a profiled alignment means (201) of a board alignment means (200) centers two continuous passages (111, 121) of the cathode board (101) and the anode board (102) corresponding to each other in an intermediate plane,
two continuous passages (111, 121) corresponding to each other for the profiled alignment means (201) are configured as an alignment hole (121) only having a circular contour (121) and an alignment hole (111) having a circular contour with protrusions (111),
an alignment means (202) of a/the board alignment means (200) aligns two continuous passages (112, 122) of the cathode board (101) and the anode board (102) corresponding to each other in one or exactly one degree of freedom in an/the intermediate plane, and/or
two continuous passages (112, 122) corresponding to each other for the alignment means (202) are configured as an alignment slot (122) in the form of an elongate hole (122), and as an alignment slot (112) in the form of a tapered or stepped elongate hole (112).

11. The assembly method (1000) according to claim 9, wherein
the cathode board (101) and the anode board (102) are fixed to each other, in in a fastening step (1002) of the assembly method (1000) after the alignment step (1001).

12. A method for stacking (2000) bipolar plates (100) to form a fuel cell stack (10) for a fuel cell, wherein
a bipolar plate stacking means (300) is used to stack (2001,2002; 2010) a plurality of bipolar plates (100) with membrane electrode assemblies (15) located between the plates to form a fuel cell stack (10), wherein
the stacking (2001, 2010) of a bipolar plate (100) to form the fuel cell stack (10) is performed by a bipolar plate positioning device (105) in the bipolar plate (100), wherein
said bipolar plate positioning device (105) is at least partially constituted by board alignment devices (110, 120) of the electrode boards (101, 102) of the bipolar plate (100), by which the electrode boards (101, 102) have been mutually aligned (1000) for their assembly to form the bipolar plate (100).

13. The stacking method (2000) according to claim 12, wherein the bipolar plate positioning device (105) comprises two board stack continuous passages (131, 132), wherein:
a single board stack continuous passage (131/132) is formed by a double continuous passage (111, 121 /112, 122) of the board alignment devices (110, 120) of the electrode boards (101, 102),
a single continuous passage (111/121, 112/122) of two continuous passages (111, 121; 112, 122) of the electrode boards (101, 102) corresponding to each other is centered or positioned by a stacking means (301, 302) of the bipolar plate stacking means (300), wherein the bipolar plate (100) is positioned in the fuel cell stack (10),
a respective board stack continuous passage (131, 132) is formed from an alignment double hole (111, 121) and an alignment double slot (112, 122) of the board alignment devices (110, 120) of the electrode boards (101, 102) of the bipolar plate (100),
a single alignment hole (111) of the alignment double hole (111, 121) is effectively centered by a stacking means (301) of the bipolar plate stacking means (300), wherein said alignment hole (111) preferably has a circular contour with protrusions (111), and/or
a single alignment slot (112) is effectively centered or positioned by a stacking means (302) of the bipolar plate stacking means (300), wherein said alignment slot (112) is preferably designed as a tapered or stepped elongate hole (112).

14. The stacking method (2000) according to claim 12, wherein
during the stacking (2001, 2002; 2010) of the bipolar plates (100), bipolar plates (100) with the membrane electrode assemblies (15) provided thereon are stacked (2010), or bipolar plates (100) and membrane electrode assemblies (15) are alternately stacked (2001, 2002),
positioning of the bipolar plate (100) during stacking (2001, 2010) of the bipolar plate (100) to form the fuel cell stack (10) is performed by a single electrode board (101/102) of the bipolar plate (100).

15. (canceled)

16. The electrode board (101/102) according to claim 1, wherein the electrode board (101/102) is a cathode board (101) or an anode board (102).

17. The electrode board (101/102) according to claim 1, wherein the fuel cell stack (10) is for a fuel cell vehicle.

18. The electrode board (101/102) according to claim 3, wherein the at least one passage (111/121, 112/122) is a continuous passage.

19. The assembly method (1000) according to claim 11, wherein the cathode board (101) and the anode board (102) are welded to each other.
